(19) United States
(12) Patent Application Publication
(10) Pub. No.: US 2025/0386818 A1
(43) Pub. Date: Dec. 25, 2025

(54) INSECT ELIMINATION DEVICE

(71) Applicant: Kevin Share, Eustis, FL (US)

(72) Inventor: Kevin Share, Eustis, FL (US)

(21) Appl. No.: 18/748,265

(22) Filed: Jun. 20, 2024

(51) Int. Cl. A01M 1/20

(52) U.S. Cl. CPC A01M 1/2055; A01M 2200/01

(57) ABSTRACT

An insect elimination device for eliminating insects in a ground dwelling includes a dome that has a diameter of no greater than 15.0 cm. In this way the dome can be positioned over an entrance to a ground dwelling of insects thereby inhibiting the insects from exiting the ground dwelling. The dome is comprised of a biodegradable material thereby enabling the dome to decompose after a sufficient duration of time. Additionally, the dome has an insecticide that is applied to the dome to eliminate the insects in the ground dwelling.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to insect devices and more particularly pertains to a new insect device for eliminating insects in a ground dwelling. The device includes a dome which is positionable over an entrance of a ground dwelling of insects to inhibit the insects from escaping the ground dwelling. The dome is infused with an insecticide to kill the insects in the ground dwelling.

### (2) Description of Related Art Including Information Disclosed Under 37 CFR 1.97 and 1.98

The prior art relates to insect devices including an insect killing device that includes a cylindrical cover which has a plurality of entrances to enable insects to enter the cylindrical cover and an insecticide bait contained in the cylindrical cover for killing the insects and an insect killing device that includes a dome which is positionable over a ground dwelling of insects and a magnifying lens integrated into the dome for intensifying sunlight to burn the insects and an insect elimination device that includes a dome that is positionable over a ground dwelling of insects and a chemical injection unit integrated into the dome for injecting carbon dioxide gas in the ground dwelling. The prior art further includes a variety of insect elimination devices that each at least includes a chemical injection unit for injecting a toxic chemical into a ground dwelling of insects to eliminate the insects in the ground dwelling. In no instance does the prior art disclose an insect elimination device that includes a dome which is positionable over a ground dwelling of insects which is comprised of a biodegradable material and an insecticide that is applied to the dome to eliminate the insects in the ground dwelling.

### BRIEF SUMMARY OF THE INVENTION

An embodiment of the disclosure meets the needs presented above by generally comprising a dome that has a diameter of no greater than 15.0 cm. In this way the dome can be positioned over an entrance to a ground dwelling of insects thereby inhibiting the insects from exiting the ground dwelling. The dome is comprised of a biodegradable material thereby enabling the dome to decompose after a sufficient duration of time. Additionally, the dome has an insecticide that is applied to the dome to eliminate the insects in the ground dwelling.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a bottom perspective view of an insect elimination device according to an embodiment of the disclosure.

FIG. 2 is a top view of an embodiment of the disclosure.

FIG. 3 is a bottom view of an embodiment of the disclosure.

FIG. 4 is a cross sectional view taken along line 4-4 of FIG. 3 of an embodiment of the disclosure.

FIG. 5 is a perspective in-use view of an embodiment of the disclosure.

### DETAILED DESCRIPTION OF THE INVENTION

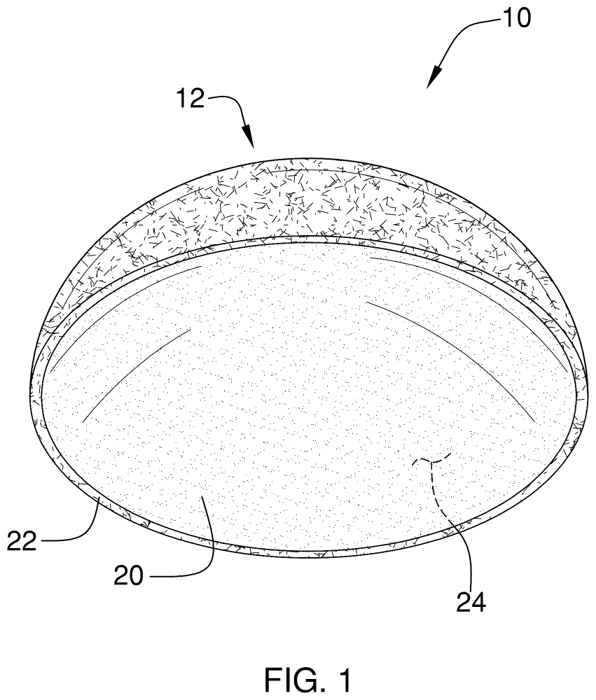

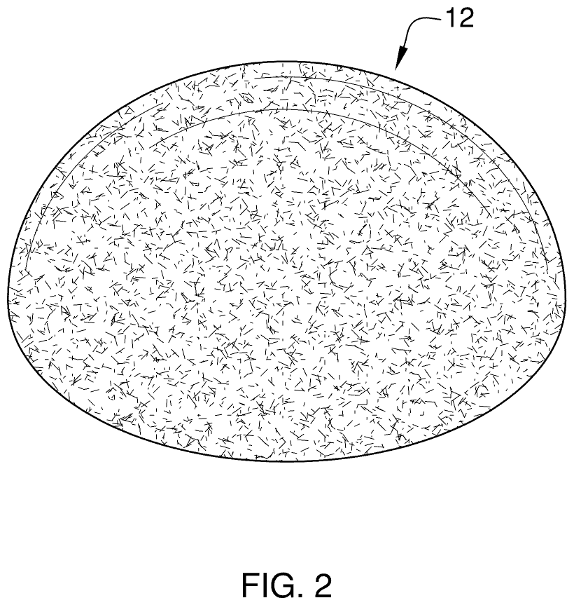

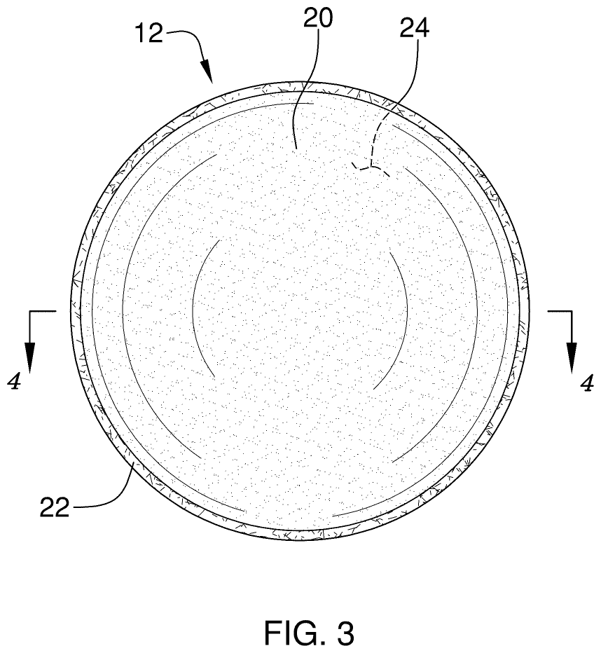

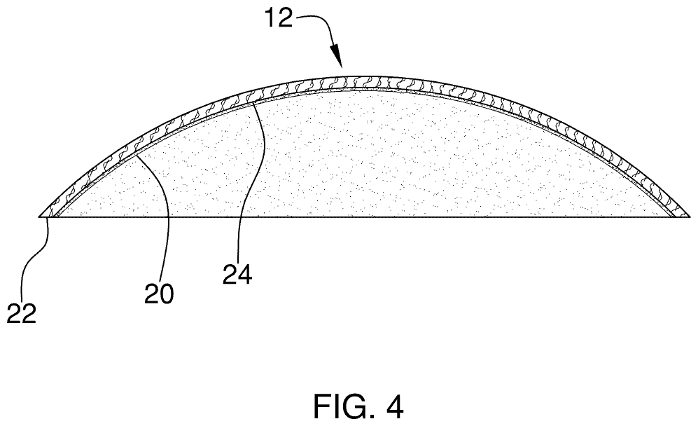

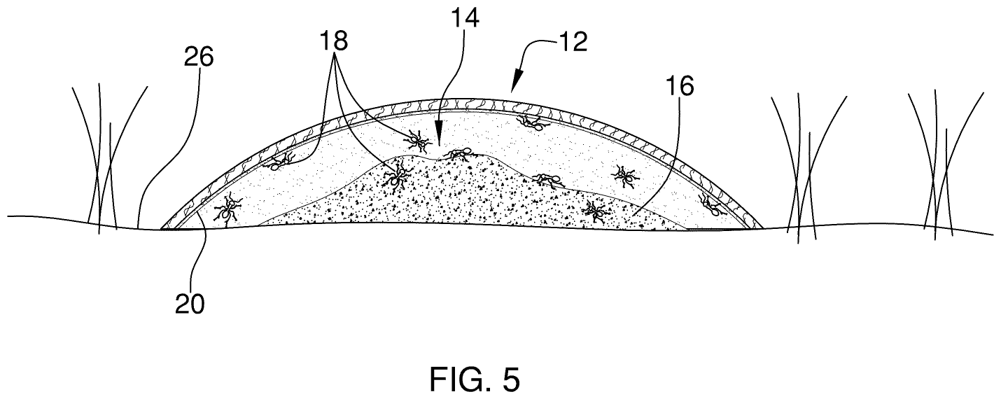

With reference now to the drawings, and in particular to FIGS. 1 through 5 thereof, a new insect device embodying the principles and concepts of an embodiment of the disclosure and generally designated by the reference numeral 10 will be described.

As best illustrated in FIGS. 1 through 5, the insect elimination device 10 generally comprises a dome 12 which has a diameter that is no greater than 15.0 cm. In this way the dome 12 can be positioned over an entrance 14 to a ground dwelling 16 of insects 18 thereby inhibiting the insects 18 from exiting the ground dwelling 16. The insects 18 may be ants, for example, and the ground dwelling 16 may be a below ground ant colony, for example. The dome 12 is comprised of a biodegradable material, including but not being limited to an organic plastic or compressed organic fibers, thereby enabling the dome 12 to decompose after a sufficient duration of time. Furthermore, the biodegradable material is resilient enough to inhibit the insects 18 from being capable of chewing through the dome 12 and subsequently escaping the ground dwelling 16.

The dome 12 has an insecticide 20 that is applied to the dome 12 to enable the insecticide 20 to eliminate the insects 18 in the ground dwelling 16. In this way the insects 18 are inhibited from leaving the ground dwelling 16 while the insects 18 are being eliminated. The dome 12 has a bottom edge 22 and a lower surface 24 which is concavely arcuate with respect to the bottom edge 22. The bottom edge 22 rests upon the ground 26 having the bottom edge 22 surrounding the entrance 14 to the ground dwelling 16 and having the lower surface 24 curving upwardly from the ground 26. The insecticide 20 is applied to the lower surface 24 such that the insecticide 20 completely covers the lower surface 24. Furthermore, the insecticide 20 comprises a mixture of bifenthrin and zeta-cypermethrin and sodium tetraborate decahydrate.

In use, a plurality of the domes 12 is sold in a stack and one of the plurality of domes 12 is removed from the stack to be positioned on the ground 26 to surround the entrance 14 to the ground dwelling 16 of the insects 18. In this way the dome 12 inhibits the insects 18 from exiting the ground dwelling 16 while the insecticide 20 eliminates the insects 18 in the ground dwelling 16. The dome 12 is left on the ground 26 until the dome 12 decomposes. In this way the dome 12 does not have to be removed from the ground 26 and disposed of when the insects 18 have been eliminated by the insecticide 20. Additionally, each of the plurality of domes 12 can be positioned over the entrance 14 of a respective one of a plurality of ground dwellings 16 in a residential yard, for example, thereby enabling the insects 18 throughout the residential yard to be simultaneously eliminated without the need to apply granular or liquid insecticide to each of the ground dwellings 16.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. An insect elimination device which is positionable over an entrance to a ground dwelling of insects for releasing an insecticide into the ground dwelling for eradicating the insects, said device comprising:
a dome having a diameter being no greater than 15.0 cm, wherein said dome is configured to be positioned over an entrance to a ground dwelling of insects thereby inhibiting the insects from exiting the ground dwelling, said dome being comprised of a biodegradable material thereby enabling said dome to decompose after a sufficient duration of time, said dome having an insecticide being applied to said dome wherein said insecticide is configured to eliminate the insects in the ground dwelling, wherein said dome has a bottom edge and a continuous and uninterrupted lower surface being concavely arcuate with respect to said bottom edge, wherein said insecticide is applied to said lower surface such that said insecticide completely covers said lower surface.

2. The device according to claim 1, wherein said bottom edge is configured to rest upon ground having said bottom edge surrounding the entrance to the ground dwelling and having said lower surface curving upwardly from the ground.

3. (canceled)

4. The device according to claim 1, wherein said insecticide comprises a mixture of bifenthrin and zeta-cypermethrin and sodium tetraborate decahydrate.

5. An insect elimination device which is positionable over an entrance to a ground dwelling of insects for releasing an insecticide into the ground dwelling for eradicating the insects, said device comprising:
a dome having a diameter being no greater than 15.0 cm, wherein said dome is configured to be positioned over an entrance to a ground dwelling of insects thereby inhibiting the insects from exiting the ground dwelling, said dome being comprised of a biodegradable material thereby enabling said dome to decompose after a sufficient duration of time, said dome having an insecticide being applied to said dome, wherein said insecticide is configured to eliminate the insects in the ground dwelling, said dome having a bottom edge and a continuous and uninterrupted lower surface being concavely arcuate with respect to said bottom edge, wherein said bottom edge is configured to rest upon ground having said bottom edge surrounding the entrance to the ground dwelling and having said lower surface curving upwardly from the ground, said insecticide being applied to said lower surface such that said insecticide completely covers said lower surface, said insecticide comprising a mixture of bifenthrin and zeta-cypermethrin and sodium tetraborate decahydrate.

6. (canceled)
